(19) United States
(12) Patent Application Publication
(10) Pub. No.: US 2005/0075152 A1
(43) Pub. Date: Apr. 7, 2005

(54) Business form construction for collecting and transmitting samples and sensitive items

(76) Inventors: Roger D. Buck, Pittsburg, KS (US); Donna J. Fletcher, Fort Scott, KS (US)

Correspondence Address: WARD KRAFT, INC., P.O. BOX 938, FORT SCOTT, KS, 66701, US

(21) Appl. No.: 10/676,356

(22) Filed: Oct. 1, 2003

(51) Int. Cl. B41L 1/20; B41L 1/22

(52) U.S. Cl. 462/64

(57) ABSTRACT

The present invention relates to a business form assembly that is suitable for collecting and transmitting samples and sensitive items. The business form construction of the present invention includes a plurality of envelopes, compartments, capture areas and the like as well as a number of independently operable closure elements to conceal and protect the sample or sensitive item contained within the assembly. The assembly of the present invention also includes one or more removable and repositionable identification pieces such as labels that are provided with indicia that matches one or more of the envelopes, compartments or capture areas of the assembly as well as collection devices to provide integrity verification between the separate components of the assembly.

### CROSS-REFERENCES TO RELATED APPLICATIONS

None.

### FIELD OF THE INVENTION

The present invention relates to a business form assembly that is suitable for collecting and transmitting samples and sensitive items. The business form construction of the present invention includes a plurality of envelopes, compartments, capture areas and the like as well as a number of independently operable closure elements to conceal and protect the sample or sensitive item contained within the assembly. The assembly of the present invention also includes one or more removable and repositionable identification pieces such as labels that are provided with indicia that matches one or more of the envelopes, compartments or capture areas of the assembly as well as collection devices to provide integrity verification between the separate components of the assembly.

### BACKGROUND OF THE INVENTION

There are various needs in the fields of law enforcement or investigative services, historic preservation, archeology, electronics industry, medical, such as samples or specimens for testing and contagious disease containment, and legal applications, banking and financial and any other endeavor that may require the collection, preservation and transmitting of the contents of a secure enclosure from one location to another.

With respect to the field of law enforcement or investigative services, an officer, detective or other investigator, such as a private investigator, forensic scientist and the like may be required to collect specimens, samples, materials, and other evidence at the scene of an event such as a crime, in order to preserve and protect any critical or important evidence that may be used in solving the crime or explaining the event that has occurred and lead to the investigating division being present. Such samples are typically used for DNA (deoxyribonucleic acid) analysis to connect a possible defendant to the crime or event. Maintaining the integrity of such samples is absolutely critical in attempting to obtain conviction of the possible defendant.

Historic preservation and archeological expeditions also may require the collection and safe-keeping of samples of material that are collected from the site, structure or location of the collection effort. For example, in the restoration of a historic building, many layers of paint may have accumulated over the years and stripping away and collecting a sample from each layer may be important in analyzing and verifying the age of the structure. In addition, such paint samples may be necessary in matching the particular or original color the structure was painted so that the restoration when completed is authentic.

Archeological expeditions require painstaking removal of debris and dirt that has amassed over a site of interest over a period of time ranging from several decades to centuries to millennia. Each layer contains invaluable information about the history of the site and may require carbon dating, chemical evaluation and other analysis to be conducted during each period of time being studied to better understand the age and speed of deterioration of the site so that additional steps may be undertaken to preserve the site. In addition, shards of pottery, vessels or containers, household pieces, human and animal remains, brick and mortar and the like, when discovered also need to be collected and transmitted in a manner so that the location can be verified and the integrity of the sample maintained so that there is no confusion about the age of the site or the inhabitants that may have occupied the site at one time.

The electronics, communications, music and recording industries also have needs for the retention and transmitting of sensitive electronic components such as circuit boards, compact discs (“CD”), master recordings, diskettes and the like. These items can have considerable value and hence the tracking and the integrity of the vehicle used to ship the sensitive components from place to place has increasing importance. In addition, the sensitive components may also have other requirements for transporting and may need static free materials or other components that do not have, create or carry electrical charges to avoid destruction of the information recorded or retained on the enclosed substance or substrate.

The medical field regularly collects samples and specimens of biological material such as tissue, blood and bone samples and matching the integrity of the sample to the patient or donor in order to ensure the adequate and proper treatment of the patient submitting the samples or from whom the samples were procured from. In addition, sample collection and preservation is also very important in areas where contagious diseases have broken out so that proper analysis can be conducted and treatment arranged for the relevant portion of the population.

The legal profession also requires a means by which to collect and preserve information, documents, samples, specimens and other evidence for clients files or in investigating certain events perpetrated on governments, institutions and the like. For example in investigating check fraud, the fraudulent checks need to be collected and secured so that the sample remains intact. In addition, sample collection from crime scenes for criminal defendants is also important as are samples and specimen collections for the purposes of evaluating infringing products and materials from competitors and the like.

Financial institutions and banks deal in high value negotiable instruments, such as stock certificates, bonds, currency and the like. The tracking and maintenance of the integrity of such parcels is critically important so that such material does not fall into the hands of unscrupulous individuals.

Each of these applications and many others not enumerated above, such as use in horticulture and collecting herbarium samples, geology, etc. require the ability to collect, retain, transmit and verify the integrity and chain of custody during each phase of the handling of the sample, specimen, etc. In addition, the availability of tamper evident features as well as the need to open and then reseal containers is also a necessary element so that samples can be removed for testing and verification at each phase of their handling and then resealed for protection and care until the next time access is required with respect to the sample.

Presently, there are a number of products available in the marketplace for certain uses. These may range from single bags with resealable, mechanical closures (hook and loop, rib and channel, etc.) with a place for indicia to be printed on the bag to more elaborate sample collection bags that may have a reusable opening to enable access to the sample and then a single re-closing of the container until the sample finally reaches its destination. Still other products include a sample collection bag that may have a record receiving ply connected to the bag so that a record can accompany the bag and a receipt attached at the place of origin to prove continuing custody of the sample or specimen unit.

Another product offering includes a bag with plural seals to open and subsequently close and secure the sample and then a plurality of labels that enable placement of a label on a specimen collector as well as on a record receipt for the purposes of record retention by the investigator or other person enclosing the sample or specimen.

While the products are generally effective for the uses that these constructions have been put to, they still however suffer from various drawbacks. Often these sample collection units are constructed of a single ply or may be made from a transparent material so that the sample may be damaged by ultraviolet degradation, or may simply be removed by someone that does not want the sample to reach its final destination.

In order to attempt to defeat this situation, such sample bags have been placed in separate boxes, bags and the like however, such a process requires that the sample collector locate such an auxiliary structure. In addition, such auxiliary structures, if the source is unknown or if care of the structure has not been continuously monitored, the structure can contaminate the sample or material contained within the bag. For example, the auxiliary structure may have a charge built up which may damage an electrical or communication component. Alternatively, if the sample collected is for DNA analysis, the outer structure may contaminate the sample bag depending on the sealing nature of the outer structure or any pathogens that may be present at the location the auxiliary structure was manufactured, located or handled.

What is needed therefor is a sample, specimen, material collection devise that lends some universality to the collection needs of various industries and which provides a composite construction that overcomes the foregoing difficulties while meeting the needs and applications for such a diverse arrangement of needs and requirements.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a unique business form construction and intermediate arrangement that is suitable for use in the collection of samples, specimens, materials and the like. In addition, the assembly of the present invention provides a number of features making the collection of materials a continuous and integrated process so that the chain of custody of the sample may be maintained and the origin of the sample easily confirmed without the necessity of additional steps such as declarations, proofs and the like.

The term layer as used in the present exemplary embodiments includes the terms structure, envelope, container or containment device, and is used to generally refer to a section or portion of a business form assembly. Layer may be used herein to refer to a layer having a single thickness or multiple plies or thicknesses making up the structure of the present invention.

The business form assembly of the present invention is constructed in a contiguous manner so that all of the elements of the sample collection unit, record recordation and retention pieces and outer secure carrier are provided in a single easy to use and convenient fashion.

In one embodiment of the present invention a business form assembly for collecting samples is described and includes; a first carrier layer that has at least first and second plies with each of them having first and second longitudinally extending side edges and first and second transversely extending end edges. The first and second plies are secured to one another along the first and second transversely extending end edges and one of the first and second longitudinally extending side edges so as to create an accessible opening between the first and second plies.

Each of the first and second plies have a length and a width and one of the first and second plies has a length or width that is longer than a corresponding length or width of the second ply. The longer length or width of the plies forms a closure flap for securing the closure flap over the opening. The carrier layer also has a first dimension.

A second collection layer is provided in the description of the present embodiment. The collection layer includes at least first and second plies with each of the first and second plies having first and second transversely extending end edges and first and second longitudinally extending side edges. The first and second plies are secured to one another along the first and second transversely extending end edges and one of the first and second longitudinally extending side edges so as to create an accessible opening between the first and second plies.

Each of the first and second plies in the presently, summarily described embodiment has a length and width and one of the first and second plies having a length or width that is longer than a corresponding length or width of the other ply. The longer length or width of the one ply forms a closure flap for securing the closure flap over the opening. In addition, the second collection layer has a second dimension distinct from the first carrier layer.

The business form assembly of the presently described summary embodiment also includes having at least one of the closure flaps for the carrier layer and the collection layer with at least two lines of weakness and at least two sealing closures, with each of the sealing closures disposed near one of the lines of weakness.

The business form assemble of the present invention and of the instant embodiment also includes a recordation layer, with the recordation layer having at least one ply that has first and second transversely extending end edges and first and second longitudinally extending side edges. The recordation layer of this assembly has a third dimension distinct from each of the carrier layer and the collection layer.

Each of the carrier layer, collection layer and recordation layer are connected to one another along at least one of the first and second longitudinal extending side edges or one of the first and second transversely extending end edges.

In a still further embodiment of the present invention, a continuous business form intermediate, is disclosed and includes a first envelope that has a length and width and an opening at one end. A second envelope that has a second length and width and has an opening at one end. The construction of the presently described summary embodiment also includes a record retention ply that has a third length and width that is distinct from each of the lengths and widths of the first and second envelopes. In addition, each of the first and second envelopes and the record retention ply are joined along an end edge.

The presently described summary embodiment also provides that each of the first and second envelopes and the record retention ply are individually removable from the end edge and that each of the first and second envelopes are independently graspable from one another without disturbing or lifting either of the record retention sheet or another of the first and second envelopes.

In a still further exemplary embodiment of the present invention a sample collection assembly is described and includes a first collection structure sized and configured to receive a first sample. A second collection structure distinct from the first collection structure and sized and configured to receive the first collection structure with the first sample enclosed therein. A third structure distinct from each of the first and second collection structures and is configured to receive information related to the first sample and the first and second collection structures, the third structure has a size that is less than each of the first and second collection structures.

The presently described summary embodiment also provides that each of the first and second collection structures along with the third structure are connected one to another along a single end edge. The collection structures and the third structure are independent and separable from one another and are secured in a juxtaposed relationship with one another.

In each of the foregoing summary embodiments, the layers, envelopes or collections structures are generally configured to receive one or more samples, specimens, segments, materials or the like or combinations of these as well as a mechanism useful in obtaining such samples such as a swab, vile and the like. In addition, in order to accomplish the use in a wide variety of fields of endeavor, one or more of the envelopes, collectors, structures, layers or the like may contain internal envelopes or sleeves that may have moisture or vapor barrier properties, be metalized films or be static or generally charge free as may be required for packaging and transporting sensitive electrical or communication based equipment or may be padded material.

In order to facilitate tracking and provide chain of custody especially with respect to evidentiary materials, one or more portions of the assembly may be provided with removable labels, such as those that are provided in an integrated or “piggy back” arrangement. The labels will typically be of the pressure sensitive type and will be printed, encoded or imaged with indicia or tags, either machine readable, such as bar code or RFID (radio frequency identification) tags or be human readable indicia including alpha and numeric characters or combinations of both.

In order to capture or record the particular sample or material to be held within the envelope, structure or collector, a record retention device is provided with suitable capture means such as carbon based sheets that are interleaved between plies or the ply and envelope, or carbonless coatings that create an image upon the rupture or mixing of the components contained within the coating or thermally sensitive coatings that upon exposure to a heated stylus create an image.

The foregoing summary embodiments will be further described in the following detailed description of the present invention and other embodiments will become evident from a review thereof.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a side view of the business form assembly of the present invention;

FIG. 2 illustrates a top view of the business form assembly of the present invention; and

FIG. 3 provides a cut away view of one of the collection or envelope assemblies of the present invention showing an internal envelope, sleeve or coating to aid in protection of the sample or specimen.

### DETAILED DESCRIPTION OF THE INVENTION

The present invention is now illustrated in greater detail by way of the following detailed description, but it should be understood that the present invention is not to be construed as being limited thereto.

As previously indicated, the present invention is directed to a collection structure that is used to hold, transport and record the collection of samples, materials, specimens, segments as may be required in a number of professional, governmental and private hobbyists pursuits. In addition, the present invention is provided with matching indicia on one or more of the removable components of the form structure so that matching of the components can occur and the integrity of the collection maintained for such evidentiary purposes or for other verification that may be needed in relation to the endeavor that has been undertaken by the collector or investigator.

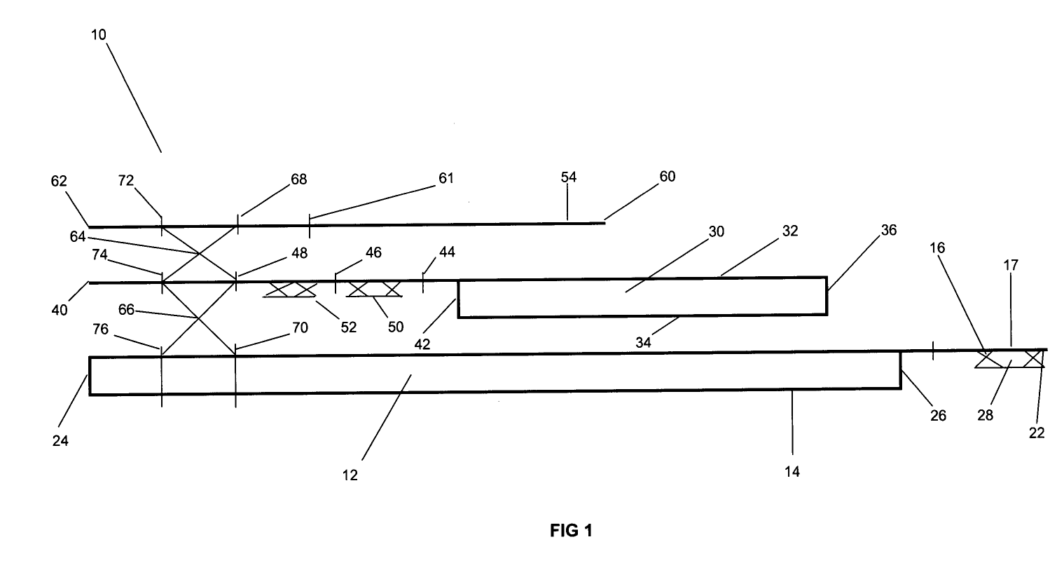

Turning now to FIG. 1 of the present invention, a side view of the present invention is provided. The business form assembly is generally depicted by reference to numeral 10. The assembly 10 includes a first carrier layer 12 that has first and second plies 14 and 16. The plies may be manufactured from any appropriate material such as plastic or metalized films, cellulosic based material such as paper, card stock and the like. In an exemplary embodiment, the carrier layer may be constructed of material ranging from 20 pound bond to 100 pound tag stock. Alternatively, TYVEK® may be used as the carrier layer 12 or other films such as polyethylene or the like. The carrier layer 12 is generally sized and configured so as to be able to carry the entire form assembly during the manufacturing process.

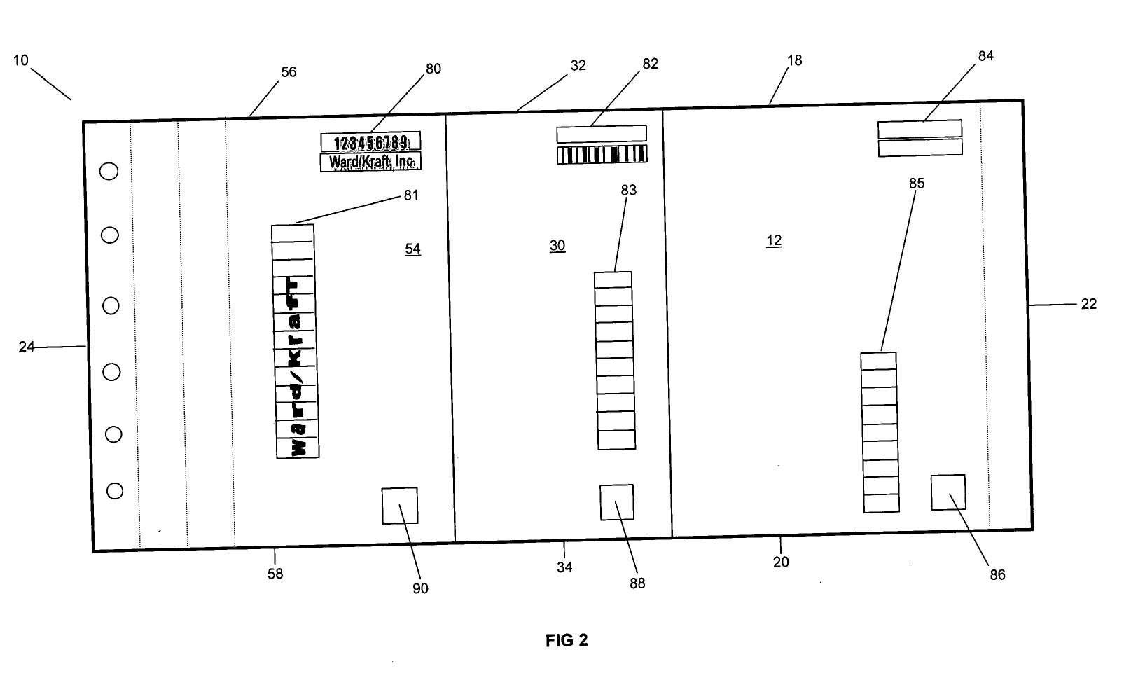

Each of the plies 14 and 16 of the carrier layer 12, has first and second longitudinally extending sides 18 and 20 (see FIG. 2) and first and second transversely extending end edges 22 and 24. The first and second longitudinally extending sides 18 and 20 are secured together along the edges or about the perimeter and one of the first and second transversely extending end edges is also secured together along the perimeter or edge. The sealing areas cooperate to form a “U” shaped configuration so as to create an access opening 26 of the carrier layer 12. One of the first and second plies, here ply number 16 is depicted, has a length that is longer than the other of the plies so as to create a closure flap 28 that extends beyond the access opening 26 so that the flap can be wrapped around and closed about the opening. Closure flap 28 is provided with a sealing closure 17 that in this exemplary embodiment includes a layer or pressure sensitive adhesive covered by a release strip, which when peeled away exposes the adhesive so that the closure flap can be sealed. It should be understood that instead of two longitudinally extending sides being sealed together along with one transversely extending end edge the two transverse edges may be sealed along with one longitudinal side to create a different opening configuration.

The carrier layer 12 has a dimension that is generally larger than that of the remaining portions of the assembly and for example may run approximately 8 1/2 by 14 inches, with the closure flap 28 extending approximately another inch or so beyond the end of the second ply. Other configurations are possible such as 8 1/2 by 11 inches or any other size that may be handled or transported depending on the demands of the particular application.

A second collection layer 30 is also provided in connection with the presently described embodiment and includes first and second plies 32 and 34. The first and second plies may be constructed of similar material to that of the carrier layer 12 or may be composed of different materials. For example, if the carrier layer 12 is prepared from a TYVEK® material the collection layer 30 may be constructed of a plastic film such as polyethylene or polystyrene. In addition, one ply of the collection layer 30 may be composed of one material and the other ply formed from another material. For example, one play may be cellulosic and the other ply made from a plastic like material so that one side is opaque and the other transparent to permit viewing of the sample or specimen.

As with the carrier layer 12, the collection layer 30 has first and second longitudinally extending sides 32 and 34 (see FIG. 2) and first and second transversely extending end edges 36 and 40.

One of the plies of the collection layer 30, depicted in FIG. 1 as ply number 32 has a longer length than ply 34 so as to create a closure flap that can be sealed around an access opening 42 that is formed by the sealing of two edges or sides as described above in connection with forming a “U” shaped perimeter seal to create the closure.

The portion of the ply 32 of the collection layer 30 that extends beyond ply 34 to form the closure flap may also be provided with multiple lines of weakness, such as perforations, score lines and the like 44, 46 and 48. In between each of the lines of weakness 44, 46 and 48 are sealing closures 50 and 52. By using such an arrangement, the collection layer may be opened several times by using an individual line of weakness and then resealed through the use of one of the sealing closures 50 and 52. Such a construction permits the enclosed sample to be analyzed, tested, evaluated, etc. for evidentiary or other purposes and then securely resealed in collection layer 30.

The sealing closures 50 and 52 may be any suitable type and preferably include a layer of pressure sensitive adhesive covered by a release liner which when removed exposes the adhesive and permits the sealing of the collection layer 30. It should be understood that any type of adhesive may be suitable for this application such as permanent, removable or repositional or combinations thereof. Adhesives such as removable or repostionable adhesives enable the collection layer to be opened and resealed before using either a permanent sealing closure or one other closure after the adhesive strength of the sealing closure weakens.

The collection layer 30, in this embodiment will typically have a dimension that is different than the dimension of the carrier layer 12. In an exemplary illustration, the dimension of the collection layer 30 may have a size of approximately 8 1/2 by 8 1/2 inches or such other dimensions as are required by the intended application.

The construction of the assembly 10 in FIG. 1 (referring also to FIG. 2) also includes a recordation layer 54. Recordation layer 54 is composed of material that is capable of receiving indicia, such as bond sheets or paper, or it may be a film to which a coating has been applied, such as polyvinyl alcohol, to provide toner anchorage for the printing or ink hold out in an ink jet application. Information can be recorded on one or both sides of the layer and pre-printed indicia may also be provided in connection with the layer so as to facilitate capture and retention of the data related to the site at which the specimen or sample was collected.

In addition to toner or ink receptive coatings, the recordation layer may be provided with thermally sensitive coatings that upon application of heated stylus or other application of thermal energy indicia will be produced or alternatively colors could be created to highlight the sensitivity of the material being submitted in the collection layer 30.

The recordation layer 54, as with the collection layer 30 and carrier layer 12 has first and second longitudinally extending sides 56 and 58 (see FIG. 2) and first and second transversely extending side edges 60 and 62 (see also FIG. 1). The recordation layer 54 has a dimension that is less than that of at least the carrier layer 12 but in an exemplary embodiment the recordation layer is also smaller than the collection layer 30.

Recordation layer 54 is also provided with a line of weakness 61 that enables the recordation layer to be detached from the form assembly 10 so as to serve as a receipt portion for the originating collection or investigation point.

Though the use of disparate dimensions each of the layers 12, 30 and 54 can be removed from the assembly without necessarily disturbing, that is lifting or separating the other layers that are to remain with the assembly.

The assembly 10 is connected through the use of a binding agent, such as adhesive 64 and 66. Binding agent 64 connects the recordation layer 54 to the collection layer 30 and binding agent 66 connects collection layer 30 to carrier layer 12. The type of adhesive is generally a permanent adhesive, such as an acrylic adhesive, but other adhesives are known to be suitable for this purpose. Other binding agents may be used to hold the forms assembly 10 of the present construction together. Such agents include staples, mechanical crimping, mechanical fasteners and the like.

As depicted in FIG. 1, the transverse edges of each of the layers 12, 30 and 54 are in substantial alignment with one another so that the layers may be juxtapositioned upon one another in the formation of the assembly 10. A portion of each of the layers, extends beyond the edge of the binding agent 64 and 66 and serves as a feeding assist for the construction as it is being assembled. Such feeding assist may be included but is not limited to tractor feed holes or the like that enable the form assembly 10 to be advanced through various stages of printing and production.

Lines of weakness 48, 68 and 70 enable each of the layers 30, 54 and 12, respectively, to be removed from the assembly 10 without the necessity of separating each of the additional layers of the form construction. Additional lines of weakness 72, 74 and 76 permit the entire assembly to be removed from the feeding assist so as to create a clean forms assembly arrangement.

As can be seen in FIG. 1, the access opening of each of the envelopes or layers 42 and 26 are disposed opposite one another, that is 180° apart from one another. It should be understood that the embodiments of the present invention are not intended to be so limited and that the access openings may instead be perpendicular to one another, that is offset by 90° or the openings 26 and 42 may be parallel with one another so that the opening is accessible from a single direction while the assembly is still connected along a single end edge margin.

Turning now to FIG. 2 of the present invention a top view of the business form assembly 10 is shown. FIG. 2 depicts that each of the layers 12, 30 and 54 have roughly equivalent width dimensions, but differing length dimensions and create something of a shingled arrangement.

As provided in FIG. 2, each of the layers 12, 30 and 54 are provided with detachable or removable labels 80, 82 and 84 each of which can be provided with machine readable indicia or device such as bar codes or human readable indicia such as alpha numeric characters. The labels may also include a tamper evident feature so that upon the attempted removal or alteration of the label, the label will rip or tear and will illustrate the attempted alternating. Alternatively, tags or chips such as “smart chips” or radio frequency identification devices can be included in the construction.

The labels included with the present invention are provided so that each set of labels matches the indicia printed on the other set of labels on the form assembly 10. That is, the indicia, regardless of whether it is machine readable or human readable, on the recordation layer 54 will match with the indicia printed or imaged on the collection layer 30 and carrier layer 12 and vice versa, so that each of the components of the assembly match one another. This matching process insures the integrity of the entire form assembly such that the origin of any portion of the assembly is not questioned when the sample or specimen is received by the testing facility or laboratory conducting the analysis of the collected sample.

In addition, FIG. 2 shows a further adaptation of the present invention in that radio frequency identification tags (“RFID”) 86, 88 and 90 can be provided on each of the plies so that the layers of the form can be scanned and captured by scanners and other receiving equipment.

FIG. 2 also provides that each component of the form assembly 10 or any individual component may be provided with pre-printed indicia 81, 83 and 85 to facilitate the capture of information to aid in the verification of the information.

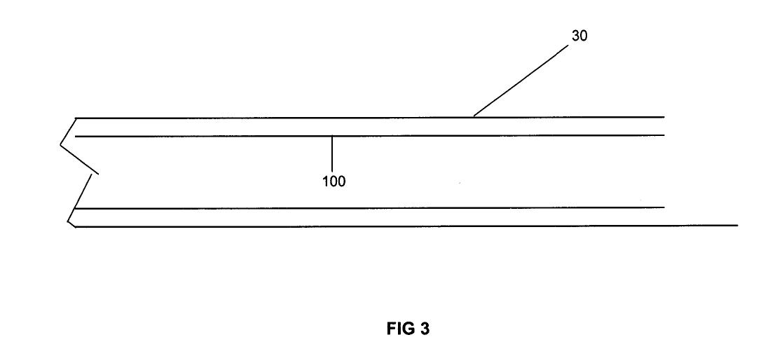

Turning now to FIG. 3, a cut away illustration is provided of one of the collection structures or envelopes 30 and illustrates the use of an internal envelope, sleeve or coating 100. Such an internal envelope, sleeve or coating may have vapor or moisture barrier properties or may be such that it is constructed to be static or charge free to avoid destruction of encoded or encrypted information. The moisture or vapor barrier material can include metalized or plastic films, scavenging aids (silicone) embedded in such films, or synthetic materials that do not carry or pass a charge onto the enclosed sample.

In a further embodiment, the inner sleeve or envelope may be constructed of a padded material such as a “bubble wrap”, corrugated cushioning, foam, sponge rubber or other spongy material. In this embodiment the internal padding serves to cushion sensitive elements from breakage during handling, such as may occur during the process through the United States Postal System (USPS).

The present invention has application to a number of uses and various endeavors, including but not limited to fields of law enforcement or investigative services, historic preservation, archeology, electronics industry, medical, such as samples or specimens for testing and contagious disease containment, and legal applications, banking and financial and any other endeavor that may require the collection, preservation and transmitting of the contents of a secure enclosure from one location to another.

It should be understood that reference to the term layer, collection assembly or envelope is intended to be interchangeable with one another with respect to the embodiments described above. Other terms that may be substituted herein include wrapper, cover, shrouds, sheaths, protective coverings and the like.

The term intermediate as used herein is used to describe a business form assembly that undergoes one or more additional processing steps before the assembly is suitable for use by the intended end user. Such additional processing steps may include but are not limited to printing, imaging, folding, sealing and the like.

In an exemplary illustration of how the present invention is utilized and referring generally to FIGS. 1 and 2, a user of the form (“user” may include an end user, intermediate user, preparer, manufacturer or any of them or others that come into contact with the form) detaches the marginal stub of each of the layers or plies of the assembly along lines of weakness 72, 74 and 67. The user would record information relevant to the collection in area 81 and the information would transfer to the underlying envelope or collection layer 30 so as to create a record of the transaction. The production of the duplicate image may occur through the use of carbon paper, carbonless coatings, thermal transfer or other means known and used in the industry. The user would then detach the recordation ply 60 for filing and record retention relating to the collection.

If a collection device is provided (not illustrated in the drawings) the user would remove the device (swab, test strip, vial, etc.) from one or both of the envelopes 12 and 30. The user would then detach a label 80 from the recordation layer and apply it to the collection device or alternatively directly to the sample to be collected.

Additional indicia may be imaged or recorded at 83 and the collection device or sample is then inserted into envelope 30 and the envelope is sealed using one of the sealing closures 50 and 52. Prior to placing the sample or collection assembly within the envelope 30, the label on the collection device or sample is matched with the label on the collection envelope 82 to insure integrity of the collection process. The collection envelope 30 may or may not still be attached via adhesive 66 and 64 to the remaining portion of the recordation layer 60 and carrier layer 12, or the envelope may have been detached along line of weakness 48 from the assembly prior to sealing.

Next, the envelope 30 containing the sample is placed within the carrier layer or first envelope 12 and the first envelope is secured via the sealing closure 28 to enclose the sample containing envelope 30. Prior to sealing, the label on the second envelope 30 is matched to verify the accuracy of the label indicia contained on the first envelope 12. The first envelope 12 is then detached along line of weakness 70 so that the first envelope 12 is now free of the marginal stubs of the assembly and may be transported through the mail or via courier or other acceptable means.

On receipt, say for instance by a laboratory that is to conduct an analysis of the sample, the first envelope 12 is opened and the second envelope 30 is removed. The indicia on labels 82 and 84 are compared to make sure a match of the two labels is positive. If the integrity is confirmed, the sample or collection device is removed by opening the second envelope through one of the lines of weakness 46 and the label 80 from the sample or collection device obtained from the recordation layer 60 is compared with the label 82 on the second envelope 30. If accurate, the laboratory can prove the chain of custody and commence review of the sample material.

Once the analysis is completed the sample is again matched with second envelope 30 via labels 80 (now on the sample) and 82 and the sample is then reinserted into the second envelope 30 and the second sealing closure 50 is used to reseal the envelope so as to maintain the integrity of the sample and prevent tampering.

The closure flaps of each of the first and second envelopes may each be provided with tamper evident features such as security slits or dies, removable ink, printed patterns, destructible films and the like to reveal any unauthorized attempted opening of the envelopes.

The first and second envelopes are sized and configured so that the second envelope will fit or nest within the first envelope. Alternatively, the envelopes could be of similar size which would then require the second envelope to be folded, rolled or otherwise reduced in size in order to enable the second envelope to fit within the first envelope.

It will thus be seen according to the present invention a highly advantageous form assembly for the collection of materials, samples, specimens and the like has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form assembly for collecting samples, comprising;
a first carrier layer, said carrier layer having at least first and second plies, each of said first and second plies having first and second longitudinally extending side edges and first and second transversely extending end edges; said first and second plies being secured to one another along said first and second transversely extending end edges and one of said first and second longitudinally extending side edges so as to create an accessible opening between said first and second plies; each of said first and second plies having a length and a width and one of said first and second plies having a length or width that is longer than a corresponding length or width of said second ply; said longer length or width of said one of said first and second plies forming a closure flap for securing said closure flap over said opening;
said carrier layer having a first dimension;
a second collection layer, said collection layer comprising at least first and second plies with each of said first and second plies having first and second transversely extending end edges and first and second longitudinally extending side edges; said first and second plies being secured to one another along said first and second transversely extending end edges and one of said first and second longitudinally extending side edges so as to create an accessible opening between said first and second plies; each of said first and second plies having a length and width with and one of said first and second plies having a length or width that is longer than a corresponding length or width of said second ply; said longer length or width of said one of said first and second plies forming a closure flap for securing said closure flap over said opening;
said second collection layer having a second dimension distinct from said first carrier layer;
at least one of said closure flaps for said carrier layer and said collection layer having at least two lines of weakness and at least two sealing closures, each of said sealing closures disposed near one of said at least two lines of weakness;
a recordation layer, said recordation layer having at least one ply having first and second transversely extending end edges and first and second longitudinally extending side edges; said recordation layer have a third dimension distinct from each of said carrier layer and said collection layer; and
wherein each of said carrier layer, collection layer and recordation layer are connected to one another along at least one of said first and second longitudinal extending side edges or one of said first and second transversely extending end edges.

2. A business form assembly as recited in claim 1, wherein said recordation layer is provided with an indicia transfer means.

3. A business form assembly as recited in claim 2, wherein said indicia transfer means is selected from a group including a carbon sheet, thermally sensitive or carbonless coating.

4. A business form assembly as recited in claim 1, wherein said business form assembly includes one or more removable labels, with each of said labels having first and second parts.

5. A business form assembly as recited in claim 4, wherein one of said first and second parts contains at least human readable indicia and another of said first and second parts contains at least machine readable indicia.

6. A business form assembly as recited in claim 5, wherein at least one of said first and second parts contains both human and machine readable indicia.

7. A business form assembly as recited in claim 1, wherein said first dimension of said carrier layer is substantially larger than each of said second dimension of said collection layer and said third dimension of said recordation layer.

8. A business form assembly as recited in claim 1, wherein said second dimension of said collection layer is larger than said third dimension of said recordation layer.

9. A business form assembly as recited in claim 1, wherein each of said carrier layer, collection layer and recordation layer have at least one each of said transversely extending end edges substantially aligned with one another.

10. A business form assembly as recited in claim 1, wherein said access opening of said collection layer is disposed opposite to that of said access opening of said carrier layer.

11. A business form assembly as recited in claim 1, wherein said collection layer is suitable for receiving samples, specimens, materials, segments, pieces and combinations thereof.

12. A business form assembly as recited in claim 1, wherein said collection layer includes an inner envelope.

13. A business form assembly as recited in claim 12, wherein said inner envelope has a barrier layer.

14. A business form assembly as recited in claim 12, wherein said inner envelope is constructed of a static or charge free material.

15. A business form assembly as recited in claim 12, wherein said inner envelope has a metalized film layer.

16. A business from assembly as recited in claim 12, wherein said inner envelope contains a padded material.

17. A business form assembly as recited in claim 1, wherein said assembly includes at least one radio frequency identification tag.

18. A business form assembly as recited in claim 1, wherein said accessible opening of said collection layer is disposed 180° from said accessible opening of said carrier layer.

19. A business form intermediate, comprising;
a first envelope having a length and width and an opening at one end;
a second envelope having a second length and width and having an opening at one end;
a record retention ply having a third length and width, said third length and width distinct from each of said lengths and widths of said first and second envelope, said record retention ply capable of receiving indicia;
each of said first and second envelopes and said record retention ply joined along an end edge; and
each of said first and second envelopes and said record retention ply being individually removable from said end edge and each of said first and second envelopes being independently graspable from one another without disturbing or lifting either of said record retention sheet or another of said first and second envelopes.

20. A business form intermediate as recited in claim 19, wherein at least one of the first and second envelopes is provided with an inner sleeve, envelope or coating.

21. A business form intermediate as recited in claim 20, wherein said inner sleeve, envelope or coating includes properties selected from a group including moisture, vapor, gas, light and combinations thereof.

22. A business form intermediate as recited in claim 19, wherein said intermediate is provided with a plurality of removable labels having indicia matching indicia provided on said record retention ply.

23. A business form intermediate as recited in claim 19, wherein said opening of said first envelope is disposed 180° from said opening of said second envelope.

24. A sample collection assembly; comprising;
a first collection structure sized and configured to receive a first sample;
a second collection structure distinct form said first collection structure and sized and configured to receive said first collection structure with said first sample enclosed therein;
a third structure distinct from each of said first and second collection structures and is configured to receive information related to said first sample and said first and second collection structures, said third structure having a size that is less than each of said first and second collection structures; and
each of said first and second collection structures along with said third structure are connected one to another along a single end edge, are independent and separable from one another and are secured in a juxtaposed relationship with one another.

25. A sample collection assembly, as recited in claim 24, wherein at least one of the first and second collection structures is provided with an inner sleeve, envelope or coating.

26. A collection assembly as recited in claim 25, wherein said inner sleeve, envelope or coating includes properties selected from a group including moisture, vapor, gas, light, padded material and combinations thereof.

27. A sample collection assembly as recited in claim 24, wherein said assembly is provided with a plurality of removable labels having indicia matching indicia provided on said record retention ply.

28. A sample collection assembly as recited in claim 24, wherein said assembly is provided with one or more radio frequency identification tags.
